(19) United States
(12) Patent Application Publication
(10) Pub. No.: US 2025/0101293 A1
(43) Pub. Date: Mar. 27, 2025

(54) PROCESS OF IMPROVING HEAVY OIL RECOVERY USING A COMBINATION OF DOWNHOLE HEATER SYSTEM, AND CHEMICAL FORMULATION COMPOSED OF SOLVENTS AND SURFACTANTS

(71) Applicant: SAUDI ARABIAN OIL COMPANY, Dhahran (SA)

(72) Inventors: Pramod Dhanaji Patil, Sugar Land, TX (US); Muhammad M. Almajid, Qatif (SA); Zuhair A. Yousef, Saihat (SA); Abdulaziz S. Al-Qasim, Dammam (SA)

(73) Assignee: SAUDI ARABIAN OIL COMPANY, Dhahran (SA)

(21) Appl. No.: 18/471,502

(22) Filed: Sep. 21, 2023

(51) Int. Cl. E21B 43/16; C09K 8/584; C09K 8/592; E21B 36/04; E21B 43/24

(52) U.S. Cl. CPC C09K 8/592; C09K 8/584; E21B 36/04; E21B 43/164; E21B 43/24

(57) ABSTRACT

A method for recovering heavy oil from a reservoir may include placing one or more downhole mechanical heaters in an injection wellbore and injecting a fluid composition through the one or more downhole mechanical heaters. The fluid composition may contain a dialkyl ether. The fluid composition may further contain a surfactant and/or water in addition to dialkyl ether. The method may further include mechanically heating the fluid composition with the one or more downhole mechanical heaters to form a heated fluid composition, mixing the heated fluid composition with the heavy oil in the reservoir, decreasing a viscosity of the heavy oil, and collecting a mixture of the heated fluid composition and the heavy oil from a production wellbore.

### BACKGROUND

Heavy oil existing in a reservoir have high viscosity and poor mobility, which leads to poor recovery of heavy oil. As such, viscosity reduction of the heavy oil is required to enhance heavy oil recovery. There are three categories for in-situ recovering techniques, i.e., thermal recovery (steam injection), chemical injection, and gas injection. These conventional in-situ recovering techniques have been employed worldwide. However, the conventional techniques suffer from low sweep and displacement efficiencies, high capital investment, potential reservoir damage and negative environmental footprints. Accordingly, there exists a need for improving a method for recovering heavy oil from a reservoir.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for recovering heavy oil from a reservoir. The method includes placing one or more downhole mechanical heaters in an injection wellbore, injecting a fluid composition through the one or more downhole mechanical heaters. The fluid composition contains a dialkyl ether. The method further includes mechanically heating the fluid composition with the one or more downhole mechanical heaters to form a heated fluid composition, mixing the heated fluid composition with the heavy oil in the reservoir, decreasing a viscosity of the heavy oil, and collecting a mixture of the heated fluid composition and the heavy oil from a production wellbore.

Furthermore, embodiments disclosed herein relate to a method for recovering heavy oil from a reservoir, including placing one or more downhole mechanical heaters in an injection wellbore and injecting a fluid composition containing a dialkyl ether and water through the one or more downhole mechanical heaters. The method further includes mechanically heating the fluid composition with the one or more downhole mechanical heaters to form a heated fluid composition, mixing the heated fluid composition with the heavy oil in the reservoir, decreasing a viscosity of the heavy oil, and collecting a mixture of the heated fluid composition and the heavy oil from a production wellbore.

Embodiments disclosed herein also relate to a method for recovering heavy oil from a reservoir, including a huff-n-puff method. Specifically, the method includes placing a downhole heater in an injection wellbore, injecting a fluid composition containing a dialkyl ether through one or more downhole mechanical heaters, and mechanically heating the fluid composition with the one or more downhole mechanical heaters to form a heated fluid composition. The injecting and the heating of the fluid composition may be performed by a huff-n-puff method. The method further includes mixing the heated fluid composition with the heavy oil in the reservoir, decreasing a viscosity of the heavy oil, and collecting a mixture of the heated fluid composition and the heavy oil from a production wellbore.

Other aspects and advantages of the claimed subject matter will be apparent from the following description and the appended claims.

### BRIEF DESCRIPTION OF DRAWINGS

FIG. 1 is a schematic diagram of a system for recovering heavy oil from a reservoir in accordance with one or more embodiments.

FIG. 2 is a flow chart of a method for recovering heavy oil from a reservoir in accordance with one or more embodiments.

FIG. 3 is a flow chart of another method for recovering heavy oil from a reservoir in accordance with one or more embodiments.

FIG. 4 is a flow chart of another method for recovering heavy oil from a reservoir, including a huff-n-puff method, in accordance with one or more embodiments.

### DETAILED DESCRIPTION

Specific embodiments of the disclosure will now be described in detail.

In the following Detailed Description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

In one or more embodiments, “downhole” may refer to objects, units, or processes that are positioned farther from the surface entry in a wellbore.

Embodiments disclosed herein generally relates to methods, compositions, and systems for recovering heavy oil from a reservoir. In one or more embodiments, the method may include placing one or more downhole mechanical heaters in an injection wellbore, injecting a fluid composition into a reservoir through the downhole mechanical heater, mechanically heating the fluid composition in the wellbore with the downhole mechanical heater to form a heated fluid composition, mixing the heated fluid composition and heavy oil in the reservoirs, decreasing a viscosity of the heavy oil, thereby increasing a mobility of the heavy oil, and collecting a mixture of the fluid composition and heavy oil from a production wellbore. In one or more embodiments, the fluid composition may contain a dialkyl ether. Alternatively, in one or more embodiments, the fluid composition may further contain a surfactant and/or water in addition to dialkyl ether.

### Fluid Composition

In one aspect, embodiments disclosed herein relate to fluid compositions for recovery of heavy oil from a reservoir. The fluid composition may contain dialkyl ether. The fluid composition containing dialkyl ether may be injected from a fluid composition injector into an injection wellbore which includes one or more downhole mechanical heaters. The injected fluid composition may be mechanically heated with one or more downhole mechanical heater to form a heated fluid composition. The fluid composition may be mixed with heavy oil in a reservoir, and a mixture of the fluid composition and heavy oil may be collected from a production wellbore.

In one or more embodiments, the dialkyl ether contained in the fluid composition may be selected from the group consisting of dimethyl ether, diethyl ether, or combination thereof.

In one or more embodiments, the fluid composition may further contain a surfactant to reduce the interfacial tension (“IFT”) between the fluid composition and heavy oil to increase the mobility of the heavy oil. The concentration of the surfactant in the fluid composition may be in a range of from 100 parts per million by weight (“ppmw”) to 1,000 ppmw. The concentration of the surfactant in the fluid composition may be in a range having a lower limit of any one of 100, 150, 200, 250, 300, 350, 400, 450, 500, 550, 600, 650, and 700 ppmw, an upper limit of any one of 400, 450, 500, 550, 600, 650, 700, 750, 800, 850, 900, 950, and 1,000 ppmw, where any lower limit may be paired with any mathematically compatible upper limit.

In one or more embodiments, a surfactant may be selected from the group consisting of anionic surfactants, cationic surfactants, amphoteric surfactants, non-ionic surfactants, and combinations thereof.

The surfactants may be selected for use under the conditions in which it will be used. For example, the fluid composition may be heated in a range of 50° C. to 300° C. with one or more downhole mechanical heater. As such, the type of surfactants used may be selected based on the thermal stability of the foam under the conditions in which it will be used. In the present disclosure, the term “thermally stable” refers to a surfactant that does not chemically degrade and is able to maintain reduction of IFT between the fluid composition and heavy oil at high temperature in the wellbore.

Examples of anionic surfactants may include, but are not limited to alkyl sulfates, alkyl sulfonates, and alkyl alkoxy sulfates. Examples of cationic surfactants may include, but are not limited to quaternary ammonium surfactants. Furthermore, non-ionic surfactants may be R—(PO)x—(EO)y, where PO is propylene oxide, EO is ethylene oxide, R is an alkyl group having 5 to 15 carbons, x and y are 1 to 40.

Alternatively, in one or more embodiments, the fluid composition may further contain water in addition to dialkyl ether.

In one or more particular embodiments, a dialkyl ether to water mass ratio of the fluid composition may be in a range of from 0.1 to 1.0. The dialkyl ether to water mass ratio of the fluid composition may be in a range having a lower limit of any one of 0.1, 0.11, 0.12, 0.13, 0.14, 0.15, 0.16, 0.17, 0.18, 0.19, 0.2, 0.25, 0.3, 0.35, 0.4, 0.5, and 0.6 and an upper limit of any one of 0.5, 0.6, 0.7, 0.75, 0.8, 0.85, 0.9, 0.91, 0.92, 0.93, 0.94, 0.95, 0.96, 0.97, 0.98, 0.99, and 1.0, where any lower limit may be paired with any mathematically compatible upper limit.

In one or more embodiments, the fluid composition may contain dialkyl ether, a surfactant, and water.

Injection strategies may vary, and amount of recovery of heavy oil may depend upon amount of dialkyl ether injected into the wellbore, heating temperature of dialkyl ether, the vaporized amount of dialkyl ether, surfactant type and amount of surfactants, oil composition and viscosity, and injection methods. For example, as the amount of dialkyl ether in the fluid composition increases, the recovery rate of the heavy oil becomes higher. In one or more embodiments, the injection method may include injecting a fluid composition (containing dialkyl ether) from a fluid composition injector through the one or more downhole mechanical heaters. Alternatively, the injection may be performed by a huff-n-puff method. The details of the methods are discussed below.

### Method for Recovering Heavy Oil From a Reservoir

Heavy oil existing in a reservoir have high viscosity and poor mobility, which leads to poor recovery of heavy oil. As such, viscosity reduction of the heavy oil is required to enhance heavy oil recovery. Thus, one or more embodiments disclosed herein relate to methods for recovering heavy oil from a reservoir, wherein the method includes injecting a fluid composition and heating the fluid composition, mixing the heated fluid composition with the heavy oil, thereby decreasing the viscosity of heavy oil, and collecting a mixture of the fluid composition and heavy oil.

In one aspect, embodiments disclosed herein relate to methods for recovering heavy oil from a reservoir. In one or more embodiments, the method may include placing one or more downhole mechanical heaters in an injection wellbore, injecting a fluid composition into a reservoir through the downhole mechanical heater, mechanically heating the fluid composition in the wellbore with the downhole mechanical heater to form a heated fluid composition, mixing the heated fluid composition and heavy oil in the reservoir, decreasing a viscosity of the heavy oil, thereby increasing a mobility of the heavy oil, and collecting a mixture of the heated fluid composition and heavy oil from a production wellbore.

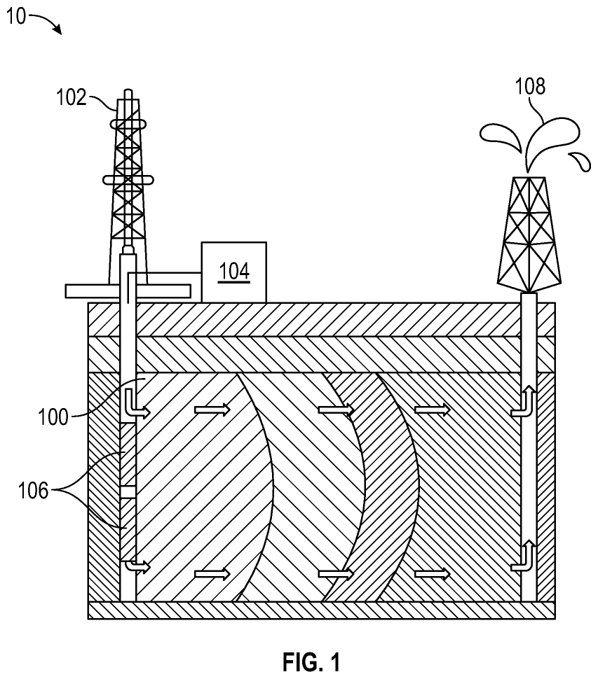

FIG. 1 illustrates a system in accordance with one or more embodiments for recovery of heavy oil. As shown in FIG. 1, the system 10 may include an injection wellbore 102 and a production wellbore 108. The injection wellbore 102 may include one or more downhole mechanical heaters 106 to heat a fluid composition injected from a fluid composition injector 104. The fluid composition injector 104 may be fluidly connected to the injection wellbore 102. The fluid composition and heavy oil mix within the reservoir 100 and the fluid composition becomes miscible with the heavy oil. The fluid composition may condense in the heavy oil, reduces the viscosity of the heavy oil, and increases the mobility of the heavy oil. A mixture of the fluid composition and heavy oil may be collected from the production wellbore 108. The arrows in FIG. 1 describe the flowing direction of the fluid composition and the heavy oil.

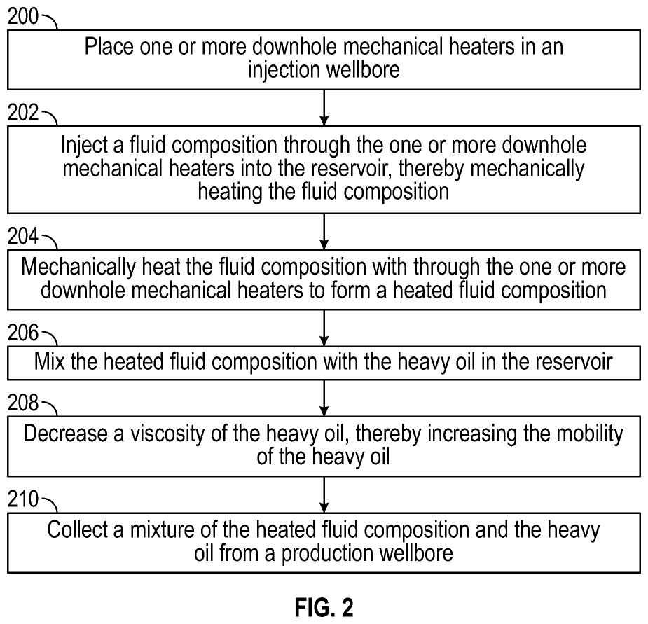

FIG. 2 shows a flowchart of a method for recovery of heavy oil in accordance with one or more embodiments.

As shown in FIG. 2 and referring back to FIG. 1, at step 200, one or more downhole mechanical heaters 106 may be disposed in an injection wellbore 102. In some embodiments, the downhole mechanical heaters 106 used for heating the fluid composition may be any known mechanical heater that may heat the fluid composition, and may be powered, for example, with batteries or from a connected power source at the surface of the wellbore. For example, the downhole mechanical heater may contain a heating element that requires a motor function. The outer body of the downhole mechanical heater may be designed to efficiently heat any wellbore fluid, wax, or asphaltene that it encounters. Furthermore, the downhole mechanical heater may be a non-steam heater.

As in step 202 of FIG. 2 and referring back to FIG. 1, a fluid composition may be injected, either continuously or intermittently, from a fluid composition injector 104 through one or more downhole mechanical heaters 106 into the reservoir 100. The fluid composition may be mechanically heated with one or more downhole mechanical heaters 106 to form a heated fluid composition (step 204). The heated fluid composition may intermix with heavy oil in the reservoir 100 (step 206) and becomes miscible with the heavy oil. The heated fluid composition may condense in the heavy oil, which reduces the viscosity of the heavy oil, and increases the mobility of the heavy oil (step 208). A mixture of the heated fluid composition and the heavy oil is then collected from a production wellbore 108 (step 210). As a result, the rate of heavy oil recovery may be improved.

As described above, in one or more embodiments, the fluid composition may be mechanically heated with the downhole mechanical heaters. Specifically, in one or more embodiments, the fluid composition may be mechanically heated to a temperature in a range of from 50°° C. to 300° C. The temperature of the heated fluid composition may be in a range having a lower limit of any one of 50, 60, 70, 80, 90, 100, 110, 120, 130, 140, 150, 200, and 250° C., and an upper limit of any one of 100, 150, 160, 170, 180, 190, 200, 250, 260, 270, 280, 290, and 300° C., where any lower limit may be paired with any mathematically compatible upper limit.

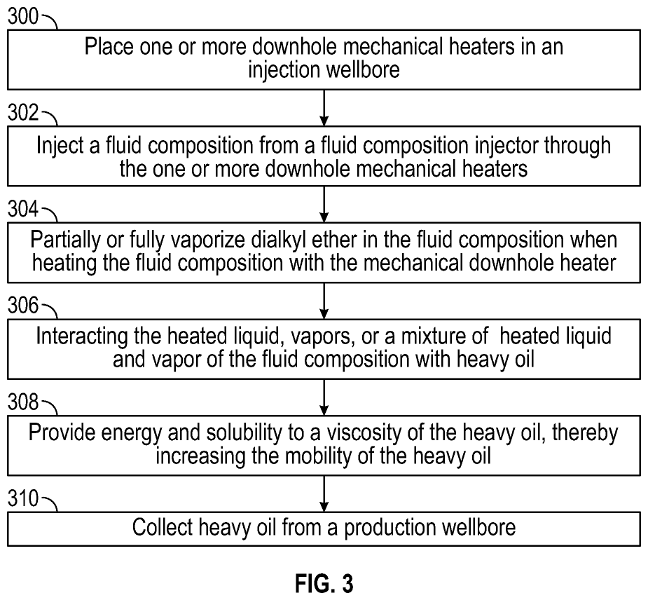

Alternatively, in one or more embodiments, the dialkyl ether contained in the fluid composition may be partially or fully vaporized. FIG. 3, shows a flow chart of a method for recovering heavy oil from a reservoir in accordance with one or more embodiments, in which the dialkyl ether contained in the fluid composition may be partially or fully vaporized.

As shown in FIG. 3 and referring back to FIG. 1, at step 300, one or more downhole mechanical heaters 106 may be disposed in an injection wellbore 102. In step 302, a fluid composition may be injected, either continuously or intermittently, from a fluid composition injector 104 through the downhole mechanical heaters 106 into the reservoir 100, and the fluid composition may be mechanically heated with the downhole mechanical heaters 106 to form a heated fluid composition. The dialkyl ether contained in the fluid composition may be partially or fully vaporized via heating of the fluid composition (step 304). The heated liquid, vapors, or a mixture of heated liquid and vapor of the fluid composition may interact with heavy oil in the reservoir 100 (step 306), and provides energy and solubility to reduce the viscosity of the heavy oil, and to increase the mobility of the heavy oil (step 308). Then, the heavy oil with increased mobility is collected from a production wellbore 108 (step 310).

Furthermore, in one or more embodiments, the method for heavy oil recovery may use a huff-n-puff method. In the present disclosure, “huff-n-puff method” refers to a cyclic process in which a well is injected with a recovery enhancement fluid and, after soaking, producing heavy oil. Specifically, a huff-n-puff method includes three stages in general: 1. to build up reservoir pressure (huff); 2. shut-in for soaking to stabilize pressure and to interact fluid with heavy oil; and 3. to produce heavy oil (puff).

Examples of the “huff-n-puff method” may include, but are not limited to, cyclic steam injection and cyclic CO₂ injection.

Specifically, in one or more embodiments, the method for heavy oil recovery may include placing a downhole mechanical heater in an injection wellbore, injecting a fluid composition comprising dialkyl ether, into a reservoir through the downhole mechanical heater, mechanically heating the fluid composition in the wellbore with the downhole mechanical heaters to form a heated fluid composition, wherein the injecting and heating of the fluid composition may be performed by a huff-n-puff method. The method may further include mixing the heated fluid composition with the heavy oil in the reservoir, decreasing a viscosity of the heavy oil, and collecting a mixture of the heated fluid composition and the heavy oil from a production wellbore.

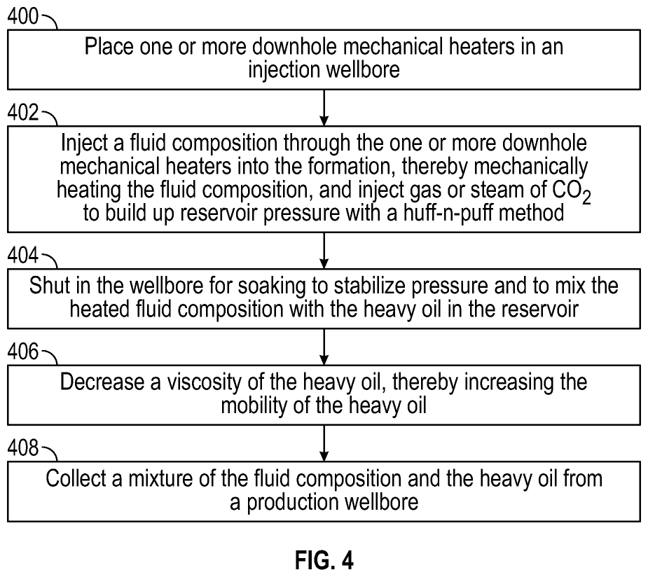

FIG. 4 shows a flowchart of a method for heavy oil recovery, including a huff-n-puff method, in accordance with one or more embodiments.

As shown in FIG. 4 and referring back to FIG. 1, at step 400, one or more downhole mechanical heaters 106 may be disposed in an injection wellbore 102. As in step 402, a fluid composition may be injected, either continuously or intermittently, from a fluid composition injector 104 through the downhole mechanical heaters 106 into the reservoir 100, and the fluid composition may be mechanically heated with the downhole mechanical heaters 106 to form a heated fluid composition. Furthermore, gas or steam of CO₂ may be injected by, for example, cyclic steam injection and cyclic CO₂ injection, and build up reservoir pressure, which refers to the first stage (huff) of the huff-n-puff method. The wellbore is then shut-in for soaking to stabilize pressure and to mix the heated fluid composition with heavy oil in the reservoir 100 (step 404) such that the heated fluid composition becomes miscible with the heavy oil (second stage of the huff-n-puff method). The dialkyl ether in the fluid composition condense in heavy oil, reduces a viscosity of the heavy oil, and increases the mobility of the heavy oil (step 406). At step 408, a mixture of the heated fluid composition and the heavy oil may be collected from a production wellbore 108 (third stage of the huff-n-puff method). As a result, the rate of heavy oil recovery may be improved.

As a result of the above methods of heavy oil recovery of one or more embodiments, a rate of heavy oil recovery may increase in a range of 30% to 50%. The heavy oil recovery rate may be in a range having a lower limit of any one of 30, 32, 34, 36, 38, 40, 42, and 44%, and an upper limit of any one of 36, 38, 40, 42, 44, 46, 48, and 50%, where any lower limit may be paired with any mathematically compatible upper limit.

Embodiments of the present disclosure may provide at least one of the following advantages. The disclosed method, composition, and system may improve the rate of heavy oil recovery by reducing viscosity and increasing mobility of heavy oil.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for recovering heavy oil from a reservoir, comprising:
placing one or more downhole mechanical heaters in an injection wellbore;
injecting a fluid composition comprising a dialkyl ether through the one or more downhole mechanical heaters;
mechanically heating the fluid composition with the one or more downhole mechanical heaters to form a heated fluid composition;
mixing the heated fluid composition with the heavy oil in the reservoir;
decreasing a viscosity of the heavy oil; and
collecting a mixture of the heated fluid composition and the heavy oil from a production wellbore.

2. The method of claim 1, wherein the fluid composition is mechanically heated to a temperature in a range of from 50° C. to 300° C.

3. The method of claim 1, further comprising partially vaporizing the dialkyl ether before injecting the heated fluid composition into the reservoir.

4. The method of claim 1, further comprising fully vaporizing the dialkyl ether before injecting the fluid composition into the reservoir.

5. The method of claim 1, wherein the fluid composition consists essentially of the dialkyl ether.

6. The method of claim 1, wherein the fluid composition consists of the dialkyl ether.

7. The method of claim 1, wherein the dialkyl ether is selected from the group consisting of dimethyl ether, diethyl ether, and a mixture thereof.

8. The method of claim 1, wherein the fluid composition further comprises a surfactant.

9. The method of claim 8, wherein a concentration of the surfactant in the fluid composition is 100 ppmw to 1,000 ppmw.

10. The method of claim 8, wherein the surfactant in the fluid composition is selected from the group consisting of anionic surfactants, cationic surfactants, amphoteric surfactants, non-ionic surfactants, and combinations thereof.

11. The method of claim 10, wherein the anionic surfactants are alkyl sulfates, alkyl sulfonates, alkyl alkoxy sulfates.

12. The method of claim 10, wherein the cationic surfactants are quaternary ammonium surfactants.

13. The method of claim 10, wherein the non-ionic surfactants are R—(PO)x—(EO)y, where PO is propylene oxide, EO is ethylene oxide, R is an alkyl group having 5 to 15 carbons, and x and y are 1 to 40.

14. The method of claim 1, wherein a rate of heavy oil recovery increases in a range of 30 to 50%.

15. A method for recovering heavy oil from a reservoir, comprising:
placing one or more downhole mechanical heaters in an injection wellbore;
injecting a fluid composition comprising a dialkyl ether and water through the one or more downhole mechanical heaters;
mechanically heating the fluid composition with the one or more downhole mechanical heaters to form a heated fluid composition,
mixing the heated fluid composition with the heavy oil in the reservoir;
decreasing a viscosity of the heavy oil; and
collecting a mixture of the heated fluid composition and the heavy oil from a production wellbore.

16. The method of claim 15, wherein a dialkyl ether to water mass ratio of the fluid composition is 0.1 to 1.0.

17. The method of claim 15, wherein the fluid composition further comprises a surfactant.

18. The method of claim 17, wherein a concentration of the surfactant in the fluid composition is 100 ppmw to 1,000 ppmw.

19. A method for recovering heavy oil from a reservoir, comprising:
placing a downhole heater in an injection wellbore;
injecting a fluid composition comprising a dialkyl ether through one or more downhole mechanical heaters;
mechanically heating the fluid composition with the one or more downhole mechanical heaters to form a heated fluid composition, wherein the injecting and the heating of the fluid composition is performed by a huff-n-puff method;
mixing the heated fluid composition with the heavy oil in the reservoir;
decreasing a viscosity of the heavy oil; and
collecting a mixture of the heated fluid composition and the heavy oil from a production wellbore.

20. The method of claim 19, wherein the fluid composition is mechanically heated to a temperature in a range of from 50° C. to 300° C.

21. The method of claim 19, wherein the dialkyl ether is selected from the group consisting of dimethyl ether, diethyl ether, and a mixture thereof.
